(19) United States
(12) Patent Application Publication
(10) Pub. No.: US 2012/0170874 A1
(43) Pub. Date: Jul. 5, 2012

(54) ECOLOGICAL PAPER PACKAGING FOR LONG-TERM-INSECTICIDE-TREATED MOSQUITO NETS

(75) Inventors: Claus Kaiser, Frankenthal (DE); Michael Hassebrauck, Messlingen (DE)

(73) Assignee: BASF SE, Ludwigshafen (DE)

(21) Appl. No.: 13/392,276

(22) PCT Filed: Aug. 24, 2010
(86) PCT No.: PCT/EP10/62328

§ 371 Date: Feb. 24, 2012

(30) Foreign Application Priority Data
Aug. 25, 2009 (EP) 09168607.1

(51) Int. Cl. B65D 33/01; B31B 1/14; B65D 75/20; B65D 33/18; B65D 30/20; B65D 30/04

(52) U.S. Cl. 383/42; 383/103; 383/102; 493/227

(57) ABSTRACT

The invention relates to a packaging for flexible sheet materials, comprising a bottom layer and a top layer whose edges are superposed, made of flexible, sheet material with a bursting strength of at least 120 kPa, where
a) the top layer and the bottom layer are joined to each other along at least 50% of their superposed edges, based on the total length of the superposed edges,
b) at least one segment of the edges which are joined to each other is joined together in a segment-like fashion, and
c) a further section of the superposed edges is provided as an opening for introducing the flexible sheet material.

The invention relates to a bilayer packaging for flexible sheet materials, such as textiles, which, as stacks of several units, are compressed to give bales in order to cause a reduction in volume, and to goods to be packaged packaged in this packaging.

When compressing goods to be packaged as stacks of several units, known as baling, a reduction in the volume of the goods to be packaged is achieved essentially by expelling air from the packagings and the goods comprised therein. The packagings which are suitable for this method are known. Thus, for example, mosquito nets are sealed into polyethylene or polypropylene bags into which holes with a diameter of approximately 0.5 cm have been punched. Upon baling, the air located between the folded-up nets, and between net and film packaging, escapes through these holes. The disadvantage of these punched holes is that they also open up a route for dirt to enter the inside of the packaging and the goods packaged therein. Also, the goods come into direct contact with the environment through the punched holes. It is precisely textiles where soiling of new goods is extremely undesired.

Moreover, film packagings may under certain circumstances retain moisture within the packaging in an undesirable fashion. Thus, the growth of mold has occasionally been observed in film-packaged mosquito nets after prolonged storage before being sold or traded, despite the punched holes.

When trading and selling textiles, there is sometimes the need to monitor each individual piece through the individual production and trading steps until it reaches the final customer. Thus, for example, some clothing traders allocate a separate number to each individual textile item, which number is also registered when the article is sold to the final customer. The WHO now recommends allocating to long-term-insecticide-treated mosquito nets a label which will not be bleached during washing and which demonstrably shows the batch number, or production number, of the net. If such information is to be discernible both from the outside on the goods to be packaged and durably on the goods themselves, the packaging, as well as the goods themselves, must usually also be provided with the corresponding information. This can be effected for example by manufacturing small numbers of packagings with the corresponding label, or the respective label must be applied to the packaging in an additional pass.

It is an object of the invention to provide a packaging which is suitable for baling and which does not suffer from the above-described disadvantages. It is intended to reduce the growth of mold on the goods to be packaged and to offer a possibility of simplifying the packaging label. Moreover, it is intended that it can be manufactured from readily biodegradable material, or material capable of being composted, in order to contribute to reducing the amount of waste.

These objects are achieved by a packaging for flexible sheet materials, comprising a bottom layer and a top layer whose edges are superposed and made of a flexible, sheet material with a bursting strength of at least 120 kPa, where
a) the top layer and the bottom layer are joined to each other along at least 50% of their superposed edges, based on the total length of the superposed edges,
b) at least one segment of the edges which are joined to each other is joined together in a segment-like fashion, and
c) a further section of the superposed edges is provided as an opening for introducing the flexible sheet material.

In the sections of the superposed edges, which sections are joined to each other in a segment-like fashion, segments which join the top layer and the bottom layer and segments which do not join the top layer and the bottom layer are arranged alternatingly. Upon baling the air can escape through the non-joined segments, while the joined segments ensure that the top layer and the bottom layer are not unduly flexed away from each other during the process. Since the openings for venting are located laterally at the edges of the packaging, and as a rule, superpose except when the air which escapes during baling applies a pressure, the entry of dirt is hindered. The goods, which are located inside, do not come into direct contact with the environment outside the packaging either, as is the case with packagings with punched holes. This advantage is especially pronounced when at least one of the two layers is folded inwardly on the edge and that side of the folding that faces the opposite layer is joined to the other layer in a segment-like fashion, since the folding screens the goods from the environment.

Surprisingly, it has emerged that even traditional, unbleached crêpe paper with 50 g/m², as is otherwise used for making coffee filters, is sufficiently strong to be used for the packagings according to the invention.

The material for the two layers which is advantageously used is a porous material such as paper, woven fabrics or nonwovens made of natural fibers or biodegradable synthetic fibers which are air-permeable and thus hinder the development of mold, can be composted comparatively readily and can be manufactured from renewable raw materials.

According to a particular embodiment of the invention, the goods, which are provided with a label such as, for example, a clothing label, are placed into a packaging provided with a fastening device in such a way that the label protrudes outwardly from the packaging and is held in place on the packaging by means of the fastener so that the label can be read easily when viewed from the outside. In this fashion, an additional labeling of the packaging with a specific mark which relates to the individual goods, such as, for example, a batch number and the like, can be dispensed with. The packaging can be manufactured beforehand in large numbers, and a separate step for labeling the packaging is not required. The occurrence of goods whose packaging label is mismatched is reduced.

The invention is described in detail in the following text.

The packaging according to the invention comprises two layers, a bottom layer and a top layer, which meet at the edges. Since a flexible sheet material is employed, it can adapt to fit the contours of the goods to be packaged, in particular when excess air is expelled from the goods to be packaged and the packaging upon baling. Here, the dimensions of the goods to be packaged may change, but the flexible packaging material will also adapt to fit this phenomenon, so that the largest possible reduction in volume can be achieved upon baling.

According to the invention, a flexible material with a bursting strength of at least 120 kPa, preferably 130 kPa and especially preferably at least 140 kPa is employed, measured as specified in ISO2758. This will withstand the forces which occur on baling and on the intended transport, or storage, and handling of the goods to be packaged. Suitable for this purpose are, for example, paper, nonwovens, wovens, knitted fabrics and plastic sheets with an appropriate bursting strength. These include, for example, long-fiber paper, crêpe paper, polyethylene or polypropylene nonwovens, cellulose nonwovens, cotton wovens, jute wovens and linen wovens, leather and synthetic leather. It is preferred in accordance with the invention to employ materials which are porous, i.e. air-permeable, but retain solids, such as paper, in particular crêpe paper and filter paper, textile woven and knitted fabrics and nonwovens. The air exchange which is made possible as a result of the porosity, between the interior of the packaging and the environment, reduces the chances of mold forming inside the packaging and on the goods to be packaged, as has been observed for example for mosquito nets packaged in polyethylene/polypropylene sheets provided with punched-out vents.

Packagings made from natural raw materials, such as materials made of wood pulp fibers, cellulose, cotton, jute and linen, are especially preferred from the ecological points of view. Paper made of wood pulp fiber, in particular, is outstandingly suitable because it is very rapidly biodegraded, i.e. rots down. According to a particularly preferred embodiment of the invention, the material employed for the bottom layer and the top layer is crêpe paper with a specific gravity of at least 40 g/m², preferably at least 45 g/m² and especially preferably at least 50 g/m². This takes the form of a long-fiber, porous paper which is creped on production and therefore shows good extensibility of approximately 5 to 7%. The crêpe paper is preferably made of pine kraft pulp, since pinewood allows the production of particularly long-fiber paper. Surprisingly, it has emerged that such paper, which has to date only been used for coffee filters, features a mechanical strength which suffices for withstanding baling and also robust handling such as dropping from a lorry.

The top layer and the bottom layer of the packaging form a pocket into which the goods to be packaged are introduced. The packaging according to the invention can therefore also be referred to as a packaging pocket or pocket-shaped packaging. In order to form the pocket for introducing the goods to be packaged, the two layers are joined to each other in accordance with the invention along at least 50%, preferably along at least 60% of their superposed edges based on the total length of the superposed edges. The width over which the two layers are joined to each other is the dimension of the joint at right angles to the outward edge in the plane of the superposed layers. It depends, inter alia, on the packaging size, the packaging material and the chosen method of joining the two layers and can be adapted readily by a person skilled in the art. For example, for a crêpe paper packaging approximately 30×50 cm in size, where the two layers are joined by means of sticking on, a good joint will be obtained with an adhesive layer approximately 0.5 to 3 cm wide at right angles to the outermost edge, whereas, in the case of polymer sheets bonded to each other, a width of only 1 mm may suffice. In the case of a paper bag with folding, the width of the joint of the top layer and the bottom layer in the folded range equals the thickness of the paper.

It is a particular feature of the invention that the top layer and the bottom layer are not joined to each other throughout the entire zone, but that they are present in a form where they are joined to each other in at least one section in a segment-like fashion.

Joined in a segment-like fashion means that, in this section, segments in which the two layers are joined to each other alternate with segments in which the two layers are not joined to each other. During baling, the excess air can escape through the openings which are formed by the segments which are not joined to each other, while the segments which are joined ensure that the two layers are held in place. During baling, the two layers will not gape unduly as a result of being held in place, and after baling, the two layers are superposed correctly as a result of being held in place, and the goods to be packaged are in this fashion enveloped and protected by the packaging.

It is preferred according to the invention that alternatingly joined segments with a length of from 1 to 15 cm, preferably from 3 to 12 cm and especially preferably from 5 to 8 cm and non-joined segments with a length of from 1 to 15 cm, preferably from 3 to 10 cm and especially preferably from 5 to 6 cm, are arranged in the sections which are joined in a segment-like fashion. According to the invention, a section joined in a segment-like fashion comprises at least 2 non-joined segments between which there is arranged a joined segment. According to the invention, it is preferred that a section which is joined in a segment-like fashion comprises at least 3 non-joined segments between which there are arranged 2 joined segments, with the non-joined and the joined segments being arranged alternatingly in the order non-joined segment (njs)-joined segment (js)-njs-js-njs.

According to the invention, sections which are joined in a segment-like fashion are considered to be joined sections. According to one embodiment of the invention, at least 50% of the joined edges, based on the total length of the joined edges, are joined to each other in a segment-like fashion.

In order to expel the excess air as rapidly and uniformly as possible from the packaging on baling, it is preferred that sections which are joined in a segment-like fashion are arranged opposite to one another. This is frequently also achieved when the sections which are joined in a segment-like fashion are arranged symmetrically.

According to the invention, the top layer and the bottom layer of the packaging can be joined with each other by any method known to a person skilled in the art as being suitable for the respective material. These methods include, for example, creasing, folding, embossing, sticking, sewing, stapling, riveting, bonding and/or sealing. Methods which are particularly well suited to paper are, for example, embossing, sticking, sewing, folding and stapling.

According to the invention, the superposed edges of the top layer and the bottom layer can be joined directly to each other. According to a preferred embodiment of the invention, however, one of the two layers, or both layers, may feature an inwardly folded edge, and the two layers can be joined to each other with the aid of the folded edge. In this context, the folded-over part of the edge may be located on the inside, i.e. between the two layers, so that the side of the inwardly folded edge which faces the other, opposite layer, is present in a form where it is joined to the other layer. In the case of the bottom layer, this corresponds to the upper side of the inwardly folded edge; in the case of the top layer, this corresponds to the underside of the inwardly folded edge. The inwardly folded edge may also be located on the outside, so that the edge of the second layer is located inside the folded first edge. In this case, the inner, of the folded edge of the first layer, which faces the second layer will be joined to the outer side of the second layer. When both the top layer and the bottom layer feature such an inwardly-directed folding, and when the folded parts of the edges are both located in the interstice of the two layers and are joined to each other, this may result in more slack with regard to the packaging height. In a section which is joined in a segment-like fashion and which is located along an inwardly folded edge, it is particularly advantageous that, as a result of the fold formed by the inward folding, the packaging material will in the zone of the non-joined segments provided for the escaping of the air, screen and protect the packaging goods from the environment.

According to the invention, there is provided a further section of the superposed edges of the top layer and the bottom layer as an opening for introducing the goods to be packaged. After the goods to be packaged have been introduced, the section provided as opening may be fastened by the above-described methods like the remaining edges which are already joined to each other.

According to a preferred embodiment of the invention, the section provided as opening for introducing the goods to be packaged is provided with a fastening device. The fastening device serves for fastening the section provided as opening, after the goods to be packaged have been introduced. This may take the form of a device capable of being fastened once or more than once.

Such a fastening device may be, for example, an adhesive strip applied to the packaging and covered with a peelable film, a tab capable of being folded down and equipped with such an adhesive strip, a tab capable of being inserted, a zip fastener, buttons, a Velcro fastener and the like. In accordance with a preferred embodiment of the invention, the fastening device comprises at least one self-adhesive layer, i.e. a layer applied to the packaging or to a tab connected to the packaging which closes the opening by means of pressure. The self-adhesive layer may be activated for example by applying moisture, heat or by peeling off a protective film. The corresponding adhesive means and adhesive compositions, and the corresponding adjuvants, are already known to the person skilled in the art, in particular for joining two paper layers.

The packaging according to the invention may feature any horizontal projection from circular to polygonal; it preferably has a circular, triangular, tetragonal, pentagonal or hexagonal horizontal projection. For the purposes of the invention, horizontal projection refers to the packaging after closing any fastening device which may be present.

An especially preferred embodiment of the packaging according to the invention has a rectangular horizontal projection, where the superposed layers are joined to each other on one lateral edge by folding, at the two lateral edges which are contiguous therewith joined with each other in a segment-like fashion, and the fourth lateral edge, which is opposite the fully joined lateral edge, forms the opening provided for introducing the flexible sheet material.

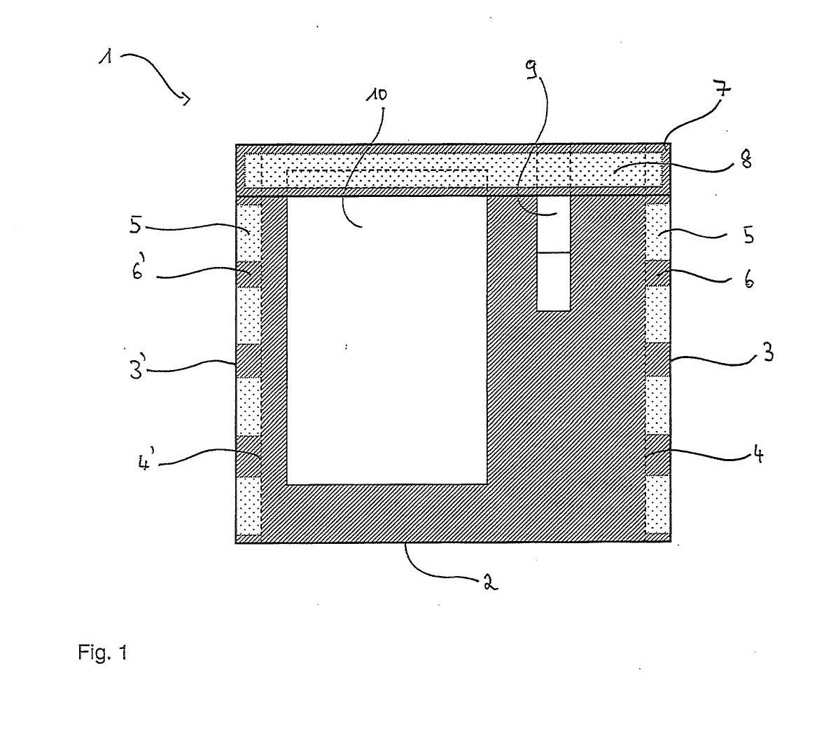

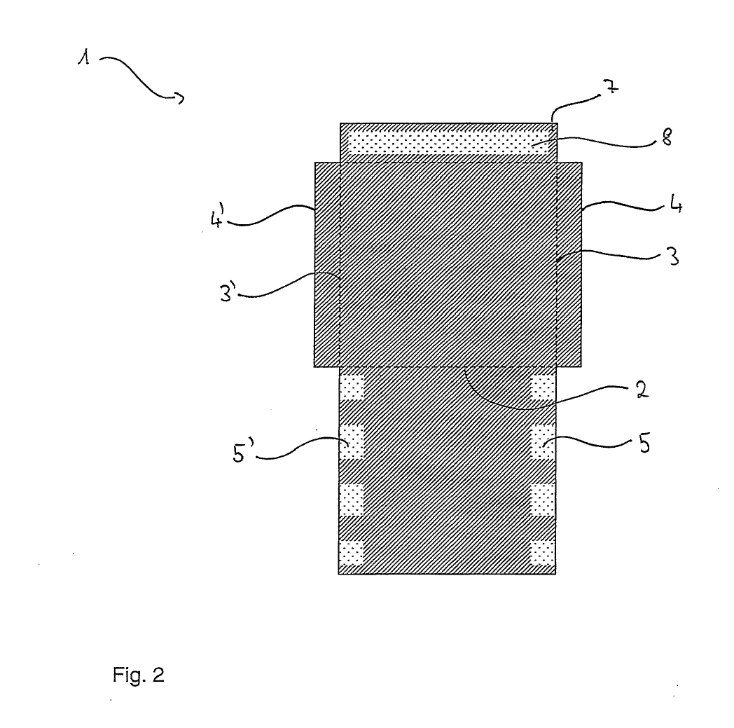

FIG. 1 shows such a preferred packaging, which is provided with a tab capable of being folded down, in the closed state including protruding label and product information, and FIG. 2 shows the pattern for the packaging according to FIG. 1 with the areas intended to join the two layers, in each case in the form of a diagram.

The packaging (1) features a rectangular horizontal projection. The two layers are joined on one lateral edge by a fold (2). The two lateral edges which are contiguous thereto are joined to each other in a segment-like fashion. Joined areas, or areas intended for this purpose, are stippled. The bottom layer also features on the lateral edges which are contiguous to the fold (2) in each case one inwardly directed fold (3, 3′), where the two edges 4, 4′ of the bottom layer are directed inwardly.

The top layer and the bottom layer are joined to each other in a segment-like fashion along the folds 3 and 3′, with segments which are joined to each other (5, 5′) and segments which are not joined to each other (6, 6′) being arranged alternatingly. The lateral edge opposite to fold (2) is designed as an opening for introducing the goods to be packaged and, in the embodiment shown, provided with a tab (7) capable of being folded down and equipped with an adhesive strip (8). Moreover, a double label (9) protrudes from the opening and is held in place by the adhesive strip (8) in such a way that it is arranged on the packaging in a highly visible fashion. Moreover, a product information sheet which is held in place by the adhesive strip (8) of the folded-down tab (7) is arranged in FIG. 1 on the outside of the packaging in such a fashion that it can be read with ease.

FIG. 2 shows a pattern (1′) before joining the two layers and before closing the packaging. The broken lines represent the creases or folds 2, 3 and 3′ which are inwardly directed and the fold provided on the side opposite fold (2) for closing the packaging with a tab (7) provided with an adhesive strip (8). The bottom part shows, on the edges, the segments 5, 5′ which are intended to be joined and which can be provided for example with a means for joining, such as adhesive.

The present invention furthermore relates to the use of the above-described packaging for packaging flexible sheet materials. These flexible sheet materials include, in particular, textiles, which encompasses home textiles, clothing textiles, garden textiles, outdoor textiles and similar. Usually, textiles are folded for packaging in order to be able to achieve small packaging dimensions. In this process, air regularly enters between the individual layers of the folded textiles. In order to avoid filling transport volumes with air, textiles are frequently reduced to a smaller volume by means of baling. Since textiles usually consist of flexible materials, they withstand the baling process without suffering damage.

The present invention furthermore relates to the production of a packaging as described above, comprising the steps
a) cutting the top layer and the bottom layer, and
b) joining the two layers.

The present invention also relates to goods to be packaged which are packaged in a packaging as described above.

It is especially preferred to use the packaging according to the invention for packaging textiles which are treated with insecticides with long-term activity. Long-term-insecticide-treated substrates are designed such that they release the insecticides which they contain over a prolonged period. Thus, for example, insecticide-impregnated mosquito nets are employed for controlling vector-transmitted diseases such as malaria, yellow fever, dengue fever, lymphatic filariasis and leishmaniasis. Besides spray applications of insecticides to internal walls of houses, the use of such nets constitutes for example one of the pillars of the global “Roll Back Malaria Partnership” project and is recommended by the WHO (World Health Organization). In order to ensure effective protection over a prolonged period, the nets must be impregnated in such a way that the insecticides are not lost even after a relatively large number of washes. Such nets which have been treated with special insecticide/binder combinations, are also referred to as LLINs (long-lasting insecticide net).

The insecticides currently being used are almost exclusively pyrethroids, since this class of insecticides not only has a high lethal effect for the insects combined with low mammalian toxicity, but also because the insect is knocked down as a result of a rapidly progressing paralysis before it manages to bite and thus transmit the disease (known as the knock-down effect).

Long-term-insecticide-treated textile materials are employed for example in the form of coverings or covers, for example for bed covers, mattresses, pillows, curtains, wall coverings, carpets, window, cupboard and door curtains, blankets, tarpaulins and canvas strips. Preferred are nets, in particular mosquito nets, for example bed nets as a protection against mosquitoes and other harmful insects.

It has emerged that the packaging according to the invention is particularly suitable for packaging long-term-insecticide-treated nets, in particular mosquito nets. Such nets are described in WO 2005/064072 A2. These nets are employed predominantly in areas where there is a high risk of malaria being transmitted. Unfortunately, waste disposal and waste recycling are so little developed in these areas that the use of packaging which rot down readily and which pollute the environment less than polyethylene or polypropylene sheets has pronounced ecological advantages.

The long-term-insecticide-treated materials share the property of releasing insecticide at low doses only. Long-term-insecticide-treated textiles can therefore be packaged very well with the packagings according to the invention. On baling, the excess air can escape through the packaging segments which are not joined to each other and which are provided for ventilation without posing a danger to the environment or humans. A fully closed packaging is not necessary, which is why the porous materials, such as paper, which are preferred as packaging material can be employed and make the development of mold more difficult. Surprisingly, it has emerged that paper as the packaging of mosquito nets comprising pyrethroids such as alpha-cypermethrin absorbs less insecticide than a comparable packaging made of polyethylene or polypropylene sheet, as demonstrated in Example 2.

In a particular embodiment, the packaging is provided with a fastening device and the goods to be packaged are provided with an adhering label, where the goods to be packaged are introduced into the packaging in such a way that the label protrudes from the opening provided for introducing the goods to be packaged and is held in place on the outside of the packaging after the closing of the packaging by means of the fastener. The label adhering to the goods to be packaged usually takes the form of tags, wash instructions, care labels and the like, which are usually made of laundry-proof or waterproof materials such as polyester wovens and the like; however, they may also take the form of non-laundry-proof labels made of board, paper and similar materials. According to the invention, the label protrudes from the packaging and is held in place on the outside of the packaging by the fastener of the packaging in such a way that it can be read from the outside. As a consequence, the packaging itself need not be provided with its own mark regarding the packaging contents. This allows the packaging to be produced independently of a batch number or a similar specific mark regarding the individuality of a certain content. As a consequence, the packagings can be produced in advance in large quantities. This lowers the production costs. Since the packaging is marked by the tag or label which protrudes and is held in place on the outside of the packaging so that it can be read from outside, an additional marking on the packaging can be dispensed with, and lack of consistency between the writing on the packaging and the contents should occur with markedly less frequency. This embodiment of the invention also offers a simple possibility of following the recommendation for the labelling of long-term-insecticide-treated Mosquito nets given by the WHO on the occasion of the 12th WHOPES Working Group Meeting of 8 to 11 Dec. 2008 in Geneva/Switzerland, without this entailing a substantial complication for the packaging. According to this recommendation, such mosquito nets should be provided with laundry-proof, permanent tags which detail at least the batch number of the production. This makes possible a precise monitoring and control of the efficiency of various nets.

The embodiment of the invention where the label which protrudes from the packaging and which is held in place on the outside so that it can be read from the outside consists of two or more sections arranged next to each other and which are provided in each case with the information on the individuality of the goods to be packaged proves to be particularly advantageous for goods to be packaged which are monitored intensively along the channels of distribution.

A further embodiment of the goods packaged in accordance with the invention is that the product information on the packaging contents is provided on a separate support and that the support is held in place on the outside of the packaging by closing the packaging. The advantage is that the packaging can be produced independently of the respective product information, while the product information is applied to a separate support, for example a printed piece of paper. Again, this lowers the costs.

The present invention is illustrated hereinbelow with reference to examples and figures.

### EXAMPLE 1

### Baling

50 long-term-insecticide-treated mosquito nets made of polyester fibers, as described in WO 2005/064072 A2, with a width of 160 cm, a length of 180 cm and a height of 150 cm and a weight of approximately 600 g were packaged in the packagings according to the invention.

The material used for the packagings was unbleached, porous crêpe paper of 50 g/m² from Melitta. This paper had a bursting strength of 140 kPa, measured as specified in ISO2758. The horizontal plan of the packaging was square with dimensions 46 cm×46 cm. The two superposed crêpe paper layers were joined to each other on one side by folding, and the two contiguous lateral edges were joined to each other in a segment-like fashion. The bottom layer was provided with an approximately 2 cm wide inward fold whose side facing the direction of the other layer was joined to the latter in a segment-wise fashion using commercially available paper adhesive. The adhesive layer was approximately 1 cm in width, the joined segments were approximately 4 to 10 cm in length, and the non-joined segments were approximately 4 to 6 cm in length. The fourth side was designed as an opening with an extending tab for introducing the mosquito net, the tab being provided with an adhesive strip provided with a peelable protective film for closing the opening.

50 of the above-described mosquito nets were packaged individually in 50 of the above-described packagings and, after peeling off the protective film of the adhesive strip, closed on the outside of the other layer by folding down the tab with the adhesive strip.

The 50 packaged mosquito nets were baled in a commercial apparatus for compressing and tying and held in place in the form of bales by means of sheets and adhesive strips. The compression process was carried out with a pressure of 8 bar in approximately 2.5 minutes. The height of the stacked packagings before baling was approximately 1.5 m; after baling, it was from 0.5 to 0.6 m.

After unpacking the bale, all 50 packagings were intact. Soiling of the mosquito nets was not observed.

### EXAMPLE 2

### Absorption of Insecticide by the Packaging on Long-Term Storage

Mosquito nets made of polyester fibers and treated with alpha-cypermethrin at a concentration of 200 mg/m² were stored in conventional polyethylene packagings with punched holes and in packagings as described in Example 1. They were stored in Thailand. At intervals of several months, the alpha-cypermethrin content of the packagings was examined. The results are shown in Table 1.

TABLE 1

| | alpha-cypermethrin content | alpha-cypermethrin |
|---|---|---|
| Storage time | [mg/g (sheet)] | content [mg/g (sheet)] |
| [number of months] | PE sheet | paper packaging |
| 6 | 0.19 | 0.11 |
| 9 | 0.22 | 0.12 |
| 13 | 0.23 | 0.08 |
| 18 | 0.48 | 0.14 |
| 25 | 0.54 | 0.14 |
| 30 | 0.49 | 0.12 |
| 38 | 0.72 | 0.21 |

Surprisingly, the packaging made of polyethylene sheet absorbs noticeably more insecticide alpha-cypermethrin than the packaging made of paper.

1-15. (canceled)

16. A packaging for flexible sheet materials, comprising a bottom layer and a top layer whose edges are superposed and made of flexible, sheet material with a bursting strength of at least 120 kPa, where
a) the top layer and the bottom layer are joined to each other along at least 50% of their superposed edges, based on the total length of the superposed edges,
b) at least one segment of the edges which are joined to each other is joined together in a segment-like fashion, and
c) a further section of the superposed edges is provided as an opening for introducing the flexible sheet material,
wherein at least 50% of the joined edges, based on the total length of the joined edges, are joined in a segment-like fashion.

17. The packaging according to claim 16, wherein the section provided as opening for introducing the goods to be packaged is provided with a fastening device.

18. The packaging according to claim 16, wherein the fastening device provided is at least one self-adhesive layer.

19. The packaging according to claim 16, wherein joined segments with a length of from 1 to 15 cm and non-joined segments with a length of from 1 to 15 cm are arranged alternating in the sections which are joined in segment-like fashion.

20. The packaging according to claim 16, wherein the top layer and/or the bottom layer feature an inwardly folder edge in the zone of the segment-like joint and are joined to the each other with the aid of the folder edge.

21. The packaging according to claim 16, wherein the material employed for the packaging is porous.

22. The packaging according to claim 16, wherein the material for the packaging is selected from the group comprising paper, nonwovens, wovens, knitted fabrics and sheets.

23. The packaging according to claim 16, wherein the material employed for the packaging is paper.

24. The packaging according to claim 16, wherein the top layer and the bottom layer are joined to each other by creasing, folding, embossing, sticking, sewing, stapling, bonding, riveting and/or sealing.

25. The packaging according to claim 16 with a rectangular horizontal plan, wherein the superposed layers are joined to each other on one lateral edge by folding, at the two lateral edges which are contiguous therewith joined with each other in a segment-like fashion, and the fourth lateral edge, which is opposite the fully joined lateral edge, forms the opening provided for introducing the flexible sheet material.

26. The production of the packaging according to claim 16, comprising the steps
a) cutting the top layer and the bottom layer, and
b) joining the two layers.

27. Goods to be packaged, which are packaged in the packaging according to claim 16.

28. Goods to be packaged according to claim 27, wherein the section of the paper packaging provided as opening is provided with a fastening device and the goods to be packaged are provided with an adhering label, and wherein the goods to be packaged are inserted into the packaging in such a way that the label protrudes from the opening provided for introducing the goods to be packaged and, after closing the packaging, is held in place on the outside of the packaging by means of the fastener in such a fashion that it can be read from the outside.

29. Goods to be packaged according to claim 27, wherein the label consists of two or more sections arranged next to each other.

30. Goods to be packaged according to claim 27, wherein the product information on the packaging contents is provided on a separate support and the support is held in place on the outside of the packaging by closing the packaging.
